(19) United States
(12) Patent Application Publication
(10) Pub. No.: US 2022/0339918 A1
(43) Pub. Date: Oct. 27, 2022

(54) POLYOLEFIN-BASED MULTILAYER ELASTIC FILMS

(71) Applicant: Dow Global Technologies LLC, Midland, MI (US)

(72) Inventors: Aleksandar Stoiljkovic, Horgen (CH); Karlheinz Hausmann, Horgen (CH)

(73) Assignee: Dow Global Technologies LLC, Midland, MI (US)

(21) Appl. No.: 17/764,653

(22) PCT Filed: Aug. 26, 2020
(86) PCT No.: PCT/US2020/047924

§ 371 Date: Mar. 29, 2022

Related U.S. Application Data
(60) Provisional application No. 62/908,114, filed on Sep. 30, 2019.

(51) Int. Cl. B32B 27/16; B32B 27/08; B32B 27/32; B32B 27/30; B32B 7/027; B32B 37/15

(52) U.S. Cl. CPC B32B 27/16; B32B 27/08; B32B 27/32; B32B 27/308; B32B 7/027; B32B 37/153; B32B 2250/03; B32B 2250/242; B32B 2250/40; B32B 2270/00; B32B 2309/025; B32B 2307/308; B32B 2307/72; B32B 2307/746; B32B 2323/04

(57) ABSTRACT

According to at least one embodiment of the present disclosure, a multilayer elastic film comprises a core layer, a first outer layer, and a second outer layer. The core layer comprises at least 75 wt % polyolefin elastomer such as an ethylene/alpha-olefin block copolymer or a propylene-based plastomer. The first outer layer and the second outer layer each comprise at least 75 wt % of an ethylene-based copolymer, wherein the ethylene-based copolymer is selected from the group consisting of: (I) greater than 50 wt % of ethylene, from 5 to 16 wt % of an α,β-ethylenically unsaturated C3-C8 carboxylic acid, and optionally, from 0.5 to 10 wt % of an alkyl acrylate; (II) from 86 to 95 wt % of ethylene, and from 5 to 14 wt % of an alkyl acrylate; and (III) combinations thereof.

### CROSS REFERENCE TO RELATED APPLICATIONS

This application claims priority to U.S. Provisional Patent Application No. 62/908,114, filed on Sep. 30, 2019, the entire disclosure of which is hereby incorporated by reference.

### TECHNICAL FIELD

Embodiments of the present disclosure are generally related to multilayer films, and are more particularly related to multilayer elastic films including polyolefins.

### BACKGROUND

Multilayer films can be utilized in various applications including personal care articles such as diapers, training pants, adult incontinence produces, and hygiene products, among others. Elasticity of such multilayer films can influence the fit of the products, particularly by accommodating movements of an individual wearing the products.

Although slip and/or anti-block additives may be added to films in order to lower roll blocking behavior, such additives may have a negative impact on post-processing of the films, such as hot melt adhesive lamination. Additionally or alternatively, low molecular weight polyolefin elastomers, which can provide enhanced elasticity, can migrate to the surface of the film and cause long-term blocking issues. Additives may be added to the films to prevent migration of these elastomers, but such additives can result in reduced elastic performance and increased stiffness of the films.

Accordingly, there remains a need for multilayer elastic films having suitable elasticity and low roll blocking.

### SUMMARY

The present compositions meet these needs by providing films having a heat resistance layer to protect against shrinkage or distortion during heat sealing and a tie layer that adheres the heat resistance layer to ink, sealant layers, and/or other polyethylene films without the need for laminating adhesives.

According to at least one embodiment of the present disclosure, a multilayer elastic film comprises a core layer, a first outer layer, and a second outer layer. The core layer comprises at least 75 wt % of an ethylene/alpha-olefin block copolymer having a density of 0.850 g/cc to 0.890 g/cc and a melt index (I₂) of from 0.5 g/10 min to 5.0 g/10 min. The first outer layer and the second outer layer each comprise at least 75 wt % of an ethylene-based copolymer, wherein the ethylene-based copolymer is selected from the group consisting of: (I) greater than 50 wt % of ethylene, from 5 to 16 wt % of an α,β-ethylenically unsaturated C3-C8 carboxylic acid, and optionally, from 0.5 to 10 wt % of an alkyl acrylate; (II) from 86 to 95 wt % of ethylene, and from 5 to 14 wt % of an alkyl acrylate; and (III) combinations thereof.

According to another embodiment of the present disclosure, the ethylene/alpha-olefin block copolymer has a melt temperature of from 115° C. to 125° C.

According to another embodiment of the present disclosure, the ethylene/alpha-olefin block copolymer has a molecular weight distribution (MWD=Mw/Mn) of from 2 to 3.

According to another embodiment of the present disclosure, the I₂ of the ethylene/alpha-olefin block copolymer is from 0.5 to 2.0 g/10 min.

According to another embodiment of the present disclosure, the core layer comprises 75 to 100 wt % of the ethylene/alpha-olefin block copolymer.

According to another embodiment of the present disclosure, a multilayer elastic film comprises a core layer, a first outer layer and a second outer layer. The core layer comprises at least 75 wt % of a propylene-based plastomer having a density of 0.860 g/cc to 0. 90 g/cc and a melt flow rate (MFR) of from 0.5 g/10 min to 5.0 g/10 min. The first outer layer and the second outer layer each comprise at least 75 wt % of an ethylene-based copolymer, wherein the ethylene-based copolymer is selected from the group consisting of: (I) greater than 50 wt % of ethylene, from 5 to 16 wt % of an α,β-ethylenically unsaturated C₃-C₈ carboxylic acid, and optionally, from 0.5 to 10 wt % of an alkyl acrylate; (II) from 86 to 95 wt % of ethylene, and from 5 to 14 wt % of an alkyl acrylate; and (III) combinations thereof.

According to another embodiment of the present disclosure, the first outer layer and the second outer layer each comprise at least 75 wt % of the ethylene-based copolymer.

According to another embodiment of the present disclosure, the first outer layer and the second outer layer each comprise from 75 to 100 wt % of the ethylene-based copolymer.

According to another embodiment of the present disclosure, the ethylene-based copolymer of the first outer layer, the second outer layer, or both has a melt index (I₂) of from 4.0 g/10 min to 20.0 g/10 min.

According to another embodiment of the present disclosure, the ethylene-based copolymer of the first outer layer, the second outer layer, or both has greater than 80 wt % of ethylene and from 7 to 11 wt % of an α,β-ethylenically unsaturated C3-C8 carboxylic acid.

According to another embodiment of the present disclosure, the ethylene-based copolymer of the first outer layer, the second outer layer, or both has from 88 to 94 wt % of ethylene, and from 6 to 12 wt % of an alkyl acrylate.

According to another embodiment of the present disclosure, the ethylene-based copolymer of the first outer layer, the second outer layer, or both has a density of from 0.920 g/cc to 0.950 g/cc.

According to another embodiment of the present disclosure, the multilayer elastic film includes less than 1 wt % of antiblock or slip additives.

According to another embodiment of the present disclosure, the multilayer elastic film is a blown film or a cast film.

According to another embodiment of the present disclosure, the multilayer elastic film is a cast film, the cast film having an unwinding force of less than 1 N/50 mm after 12 weeks at a length ranging from 10 m to 50 m.

These and other embodiments are described in more detail in the following

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Multilayer film” means any structure having more than one layer. For example, the multilayer structure may have two, three, four, five or more layers. A multilayer film may be described as having the layers designated with letters. For example, a three layer structure having a core layer B, and two external layers A and C may be designated as A/B/C. Likewise, a structure having two core layers B and C and two external layers A and D would be designated A/B/C/D. Additionally, the skilled person would know that further layers E, F, G, etc. may also be incorporated into this structure.

As used herein, a “polyolefin” refers to an olefin-based polymer. As used herein, an “olefin,” which may also be referred to as an “alkene,” refers to a linear, branched, or cyclic compound including carbon and hydrogen and having at least one double bond. As used herein, when a polymer or copolymer, e.g., the polyolefin elastomer, is referred to as comprising an olefin, the olefin present in the polymer or copolymer is the polymerized form of the olefin. For example, if the polyolefin elastomer is said to have an ethylene content of 75 wt % to 85 wt %, it is understood that the polymer unit in the polyolefin elastomer is derived from ethylene in the polymerization reaction and the derived units are present at 75 wt % to 85 wt %, based on the total weight of the polyolefin elastomer.

As used herein, an “elastomer” refers to a material that will substantially resume its original shape after being stretched. For instance, upon application of a stretching force, an elastomer is stretchable in at least one direction, such as the cross machine direction, and, upon release of the stretching force, contracts/returns to approximately its original dimension. For example, an example elastomer is a stretched material having a stretched length which is at least 50% greater than its relaxed, unstretched length, and which will recover to within at least 50% of its stretched length upon release of the stretching force. A hypothetical example would be a one (1) inch sample of a material which is stretchable to at least 1.50 inches and which, upon release of the stretching force, will recover to a length of not more than 1.25 inches.

As used herein, the term “ethylene/alpha-olefin block copolymer” refers to polymers comprising ethylene and an alpha-olefin having three or more carbon atoms. The ethylene may comprise the majority mole fraction of the ethylene/alpha-olefin block copolymer. For example, the ethylene may comprises at least 50 mol %, at least 60 mol %, at least 70 mol %, at least 80 mol %, or at least 90 mol % of the ethylene/alpha-olefin block copolymer, with the remainder of the ethylene/alpha-olefin block copolymer being at least one other comonomer, such as an alpha-olefin having three or more carbon atoms.

A “propylene-based plastomer” is a propylene/ethylene copolymer having from 3 wt %, or 4 wt %, or 5 wt %, or 6 wt %, or 7 wt % to 8 wt %, or 9 wt %, or 10 wt %, or 11 wt %, or 12 wt %, or 13 wt %, or 14 wt %, or 15 wt % ethylene comonomer (based on total weight of the plastomer). The propylene-based plastomer has a heat of fusion less than 100 J/g and an Mw/Mn less than 3.5. The propylene-based plastomer has a heat of fusion less than 40 J/g when the ethylene comonomer content is from 10 wt %, or 11 wt %, or 12 wt % to 13 wt %, or 14 wt %, or 15 wt %.

Reference will now be made in detail to multilayer film embodiments of the present disclosure, which exhibit improved elasticity and low roll blocking as compared to other films.

Blocking is an adhesion between two contacting portions, e.g., layers or sheets, of a film. While not wishing to be bound by theory, blocking may result due to Van der Waal's forces between the two contacting portions of the film and/or the presence of relatively low molecular weight components of the film migrating toward the film surface. For a number of applications, blocking may be an undesirable property, as the blocking can result in increased friction between the two contacting portions.

Various embodiments include multilayer films including a core layer adjacent to a first outer layer and a second outer layer. For example, the core layer may be formed between, e.g., contacting, the first and second outer layers. The outer layers may comprise the same composition as one another. However, in some embodiments, the first outer layer may have a composition that is different from the composition of the second outer layer.

### Core Layer

The core layer includes at least 75 weight percent (wt %) of a polyolefin elastomer based on a total weight of the core layer. For example, the core layer can include from 75 wt % to 100 wt % of the polyolefin elastomer based on a total weight of the core layer. All individual values and subranges from 75 wt % to 100 wt % are included. For example, the core layer can include the polyolefin elastomer from a lower limit of 75 wt %, 76 wt %, 77.5 wt %, or 80 wt % to an upper limit of 100 wt %, 99.5 wt %, 99 wt %, 97 wt %, or 95 wt % based on the total weight of the core layer.

In various embodiments, the polyolefin elastomer may comprise an olefin block copolymer, for example, an ethylene/alpha-olefin block copolymer. Commercial examples of ethylene/alpha-olefin block copolymer include resins available under the trade name INFUSE™ available from The Dow Chemical Company (Midland, Mich.).

In various embodiments, the ethylene/alpha-olefin block copolymer may comprise ethylene and one or more copolymerizable alpha-olefins in polymerized form, characterized by multiple blocks or segments of two or more polymerized monomer units differing in chemical or physical properties. The polyolefin elastomers can be multi-block copolymers. In one or more embodiments, the multi-block copolymer can be represented by the formula (AB)n where n is at least 1, preferably an integer greater than 1, such as 2, 3, 4, 5, 10, 15, 20, 30, 40, 50, 60, 70, 80, 90, 100, or higher, “A” represents a hard block, and “B” represents a soft block. In embodiments, As and Bs are linked in a substantially linear fashion, as opposed to a substantially branched or substantially star-shaped fashion. In one or more embodiments, A blocks and B blocks are randomly distributed along the polymer chain and do not have a structure as follows: AAA-AA-BBB-BB. In some embodiments, the block copolymers do not have a third type of block, which comprises different comonomers. In embodiments, each of block A and block B has monomers or comonomers substantially randomly distributed within the block, such that neither block A nor block B comprises two or more sub-segments of distinct composition, such as a tip segment, that has a substantially different composition than the rest of the block.

The ethylene/alpha-olefin block copolymer can include various amounts of “hard” and “soft” blocks. “Hard” blocks refer to blocks of polymerized units in which ethylene is present in an amount greater than about 95 wt %, and preferably greater than about 98 wt %, based on the weight of the polymer. In other words, the comonomer content, i.e., the content of monomers other than ethylene, in the hard blocks is less than about 5 wt %, and preferably less than about 2 wt %, based on the weight of the polymer. In one or more embodiments, the hard blocks comprise all or substantially all ethylene. “Soft” blocks, on the other hand, refer to blocks of polymerized units in which the comonomer content, i.e., the content of monomers other than ethylene, is greater than about 5 wt %. For example, the comonomer content may be greater than about 5 wt %, greater than about 8 wt %, greater than about 10 wt %, or greater than about 15 wt %, based on the weight of the polymer. In various embodiments, the comonomer content in the soft blocks can be greater than about 20 wt %, greater than about 25 wt %, greater than about 30 wt %, greater than about 35 wt %, greater than about 40 wt %, greater than about 45 wt %, greater than about 50 wt %, or greater than about 60 wt %, based on the weight of the polymer.

In various embodiments, the soft blocks are present in the ethylene/alpha-olefin block copolymer at amounts from about 1 wt % to about 99 wt % of a total weight of the polyolefin elastomer. For example, the soft blocks can be present in the ethylene/alpha-olefin block copolymer from about 5 wt % to about 95 wt %, from about 10 wt % to about 90 wt %, from about 15 wt % to about 85 wt %, from about 20 wt % to about 80 wt %, from about 25 wt % to about 75 wt %, from about 30 wt % to about 70 wt %, from about 35 wt % to about 65 wt %, from about 40 wt % to about 60 wt %, or from about 45 wt % to about 55 wt % of the total weight of the polyolefin elastomer. Conversely, the hard blocks can be present in similar ranges. The soft block and hard block weight percentages can be calculated based on data obtained from DSC or NMR. Such methods and calculations are disclosed in U.S. Patent Application Publication No. 2006/0199930.

Examples of alpha-olefin comonomers that may be used to form the ethylene/alpha-olefin block copolymer include, by way of example and not limitation, propylene, isobutylene, 1-butene, 1-pentene, 1-hexene, 1-heptene, 1-octene, 1-nonene, 1-decene, and 1-dodecene, 1-tetradecene, 1-hexadecene, 1-octadecent, 1-eicosene, 3-methyl-1-butene, 3-methyl-1-penten, 4-methyl-1-penten, 4,6-dimethyle-1-heptene, 4-vinylcyclohexene, vinylcyclohexane, norbornadiene, ethylidene norbornene, cyclopentene, cyclohexene, dicyclopentadiene, cyclooctene, C₄-C₄₀ dienes, other C₄-C₄₀ alpha-olefins, and the like. In a further embodiment, the alpha-olefin comonomers may comprise C₃-C₈ comonomers. Comonomer content may be measured using any suitable technique, such as techniques based on nuclear magnetic resonance (“NMR”) spectroscopy, and, for example, by ¹³C NMR analysis as described in U.S. Pat. No. 7,498,282, which is incorporated herein by reference.

In various embodiments, the ethylene/alpha-olefin block copolymer has a melt index (I₂) of from about 0.5 to about 30.0 g/10 min, as determined in accordance with ASTM D1238 (190° C.; 2.16 kg). For examples, the polyolefin elastomer may have a melt index (I₂) of from 0.5 to 30.0 g/10 min, from 0.5 to 15 g/10 min, from 0.5 g/10 min to 5.0 g/10 min, or from 0.5 g/10 min to 2.0 g/10 min.

In various embodiments, the ethylene/alpha-olefin block copolymer has a density of 0.850 g/cc to 0.890 g/cc. All individual values and subranges from 0.850 g/cc to 0.890 g/cc are included herein and disclosed herein; for example, the density of the ethylene/alpha-olefin block copolymer can be from a lower limit of 0.850 g/cc, 0.855 g/cc, 0.860 g/cc, 0.865 g/cc, or 0.870 g/cc to an upper limit of 0.890 g/cc, 0.885 g/cc, 0.880 g/cc, or 0.875 g/cc.

The ethylene/alpha-olefin block copolymer has a melt temperature (Tₘ) (DSC) of from 115° C. to 125° C. All individual values and subranges from 115° C. to 125° C. are included herein and disclosed herein; for example, the melting point of the ethylene/alpha-olefin block copolymer can be from a lower limit of 115° C., 116° C., 117° C., 118° C., 119° C., or 120° C. to an upper limit of 125° C., 124° C., 123° C., 122° C., or 121° C.

In some embodiments, the ethylene/alpha-olefin block copolymer has a molecular weight distribution (MWD) of 3.5 or less. Molecular weight distribution (MWD) is defined as weight average molecular weight (Mw) divided by number average molecular weight (Mn). For example, the ethylene/alpha-olefin block copolymer of some embodiments has a MWD of from 2 to 3. Techniques for determining molecular weight (Mn and Mw) and MWD may be found in U.S. Pat. No. 4,540,753, which is incorporated by reference herein.

The ethylene/alpha-olefin block copolymer can be formed utilizing known polymerization processes, such as those described in PCT Application No. PCT/US2005/008915, PCT Application No. PCT/US2005/008916, and PCT Application No. PCT/US2005/008917, each of which is hereby incorporated by reference herein.

In other embodiments, the polyolefin elastomer may comprise propylene-based plastomer. In an embodiment, the propylene-based plastomer is a propylene/ethylene copolymer with from 3 wt % to less than 10 wt % ethylene comonomer and having one, some, or all of the following properties: (i) a density from 0.860 g/cc, or 0.870/cc, or 0.880 g/cc to 0.885 g/cc, or 0.890, or 0.895, or less than 0.90 g/cc, measured in accordance with ASTM D792; (ii) a vicat softening temperature from 60° C., or 61° C., or 62° C. to 63° C., or 64° C., or 65° C.; (iii) a melting temperature, Tₘ, from 70° C., or 73° C., or 75° C., or 77° C., or 79° C. to 80° C., or 82° C., or 83° C. to 85° C., or 87° C., or 89° C., or 90° C.; and (iv) a melt flow rate (MFR) from 0.5 g/10 min, or 1.0 g/10 min, or 1.5 g/10 min, or 2.0 g/10 min, or 2.5 g/10 min to 3.0 g/10 min, or 3.5 g/10 min, or 4.0 g/10 min, or 4.5 g/10 min, or 5.0 g/10 min, as determined in accordance with ASTM D1238 (230° C., 2.16 kg). Vicat softening temperature is the determination of the softening point for materials that have no definite melting point. Vicat softening temperature is measured in accordance with ASTM D 1525.

Non-limiting examples of suitable propylene-based plastomer include VERSIFY™ 2400 and VERSIFY™ 2300, available from The Dow Chemical Company (Midland, Mich.).

In embodiments, in addition to the polyolefin elastomer, the core layer can further include one or more additives. Examples of additives include, by way of example and not limitation, viscosity reducing polymers, plasticizers, tackifiers, dyes, pigments, antioxidants, antistatic agents, bonding aids, heat stabilizers, photostabilizers, foaming agents, glass bubbles, starch, metal salts, microfibers, or the like. In some embodiments, one or more elastomeric materials, such as styrene-ethylene-butene-styrene (SEBS) block copolymer or the like, is added to the core layer to further improve elastic performance. When present, any additives are included in the core layer in an amount of 25 wt % or less. For example, the core layer may include from 0 wt % to 25 wt %, from 1 wt % to 25 wt %, from 5 wt % to 20 wt %, from 10 wt % to 15 wt %, or the like. All individual values and subranges from 0 wt % to 25 wt % are included herein and disclosed herein.

### Outer Layers

In various embodiments, the multilayer film further includes a first outer layer and a second outer layer. Each outer layer includes at least 75 wt % of an ethylene-based copolymer. For example, the outer layer can include from 75 wt % to 100 wt % of the ethylene-based copolymer based on a total weight of the outer layer. All individual values and subranges from 75 wt % to 100 wt % are included. For example, the outer layer can include the ethylene-based copolymer from a lower limit of 75 wt %, 76 wt %, 77.5 wt %, or 80 wt % to an upper limit of 100 wt %, 99.5 wt %, 99 wt %, 97 wt %, or 95 wt % based on the total weight of the outer layer.

In some embodiments, the ethylene-based copolymer is an ethylene acid copolymer. The ethylene acid copolymer is a polymerized reaction product of ethylene and one or more carboxylic acids, and may optionally include an alkyl acrylate. The ethylene can be present in an amount of greater than 50 wt %, based on a total weight of the ethylene acid copolymer. For example, the ethylene acid copolymer can include from 50 wt % to 95 wt % ethylene, from 55 wt % to 90 wt % ethylene, from 60 wt % to 85 wt % ethylene, from 65 wt % to 80 wt % ethylene, or from 70 wt % to 75 wt % ethylene. The ethylene acid copolymer can include greater than 60 wt % ethylene, greater than 70 wt % ethylene, or greater than 80 wt % ethylene, based on a total weight of the ethylene acid copolymer. All individual values and subranges from 75 wt % to 95 wt % are included.

In various embodiments, the carboxylic acid is an α,β-ethylenically unsaturated C₃-C₈ carboxylic acid. The carboxylic acid can be, for example, acrylic acid, methacrylic acid, fumaric acid, itaconic acid, maleic acid, aconitic acid, various α-substituted acrylic acids, or combinations thereof. In various embodiments, the α,β-ethylenically unsaturated C₃-C₈ carboxylic acid is present in an amount of from 5 wt % to 16 wt %, from 6 wt % to 15 wt %, or from 7 wt % to 11 wt % based on a total weight of the monomers present in the ethylene acid copolymer. All individual values and subranges from 5 wt % to 16 wt % are included.

In some embodiments, the ethylene acid copolymer optionally includes an alkyl acrylate. In embodiments in which an alkyl acrylate is included, it can be present in an amount of from 0.5 wt % to 10 wt %. For example, the alkyl acrylate can be included in an amount of from 0.5 wt % to 10 wt %, from 1 wt % to 9 wt %, from 2 wt % to 8 wt %, or from 3 wt % to 7 wt %. All individual values and subranges from 0.5 wt % to 10 wt % are included.

Suitable ethylene acid copolymers may include those commercially available under the trade names NUCREL™, such as NUCREL™ 3990 (available from The Dow Chemical Company, Midland, Mich.), PRIMACOR™ (available from SK Global Chemical), and ESCOR™ (available from ExxonMobil Chemical).

In still other embodiments, the ethylene-based copolymer is a copolymer of ethylene and an alkyl acrylate. The ethylene can be present in an amount of from 86 wt % to 95 wt %, based on a total weight of the ethylene-based copolymer. For example, the ethylene-based copolymer can include from 86 wt % to 95 wt % ethylene, from 87 wt % to 94 wt % ethylene, or from 88 wt % to 94 wt % ethylene. All individual values and subranges from 86 wt % to 95 wt % are included.

Suitable acrylate copolymers may include ethyl methyl acrylate (EMA), ethylene ethyl acrylate (EEA), and ethylene butyl acrylate (EBA). The ethylene acrylate copolymer may have a comonomer level of maleic anhydride (MA), ethyl acrylate (EA) or butyl acrylate (BA) wt % of from 5.0 wt % to 50 wt %, from 10 wt % to 45 wt %, from 15 wt % to 40 wt %, or from 20 wt % to 35 wt %. The ethylene acrylate copolymer may have a melt index (I₂) of from 4 to 20 g/10 min, from 4 to 15 g/10 min, from 4 to 12 g/10 min, or from 5 to 10 g/10 min, as determined in accordance with ASTM D1238 (190° C.; 2.16 kg). Examples of commercially available copolymer resins which may be used in some embodiments include ELVALOY™ 1609AC which are all available from The Dow Chemical Company, Midland, Mich.

In such embodiments, the alkyl acrylate can be present in an amount of from 5 wt % to 14 wt %, based on a total weight of the ethylene-based copolymer. For example, the alkyl acrylate may be present in an amount from 5 wt % to 14 wt %, from 6 wt % to 13 wt %, or from 6 wt % to 12 wt %, based on a total weight of the ethylene-based copolymer. All individual values and subranges from 5 wt % to 14 wt % are included. Without being bound by theory, this alkyl acrylate range provides suitable adhesion properties for the ethylene-based copolymers whereas ethylene-based copolymers with greater than 14% alkyl acrylate are too tacky and thus lead to poor roll blocking properties.

Although in some embodiments, the ethylene-based copolymer is an ethylene acid copolymer or an ethylene-alkyl acrylate copolymer, it is contemplated that in other embodiments, the ethylene-based polymer can include combinations of the copolymers. For example, the outer layer can include an ethylene acid copolymer and an ethylene-alkyl acrylate copolymer.

In various embodiments, the ethylene-based copolymer of the outer layer has a density of from 0.920 to 0.950 g/cc, from 0.920 to 0.945 g/cc, or from 0.925 to 0.940 g/cc, in some embodiments.

Additional compositions and additives are also contemplated to be included in the outer layers. Examples of additives include, by way of example and not limitation, viscosity reducing polymers, plasticizers, tackifiers, dyes, pigments, antioxidants, antistatic agents, bonding aids, heat stabilizers, photostabilizers, foaming agents, glass bubbles, starch, metal salts, microfibers, or the like. In some embodiments, the outer layers may include a mineral filler, such as CaCO₃, which can be beneficial in the extrusion process.

### Multilayer Film

As described above, various embodiments include a multilayer form including a core layer adjacent to a first outer layer and a second outer layer. The multilayer films may be formed by a variety of processes. For example, the multilayer films may be formed by a blown film process or a cast film process.

Blown film processes may utilize an extruder to heat, melt, and convey the components of the multilayer film to a die. Each layer of the multilayer film may have a corresponding stream introduced to the die. Generally, extrusion temperatures are from 150° C. to 275° C., although the particular temperature can vary depending on the particular film composition. The components of the multilayer film can be drawn from the die, formed into a tube shape, and passed through a pair of draw or nip rollers. Internal compressed air can then be introduced from a mandrel, causing the tube to increase in diameter, thereby forming a “bubble” of a desired size. Thus, the blown film can be stretched in two directions, namely, in an axial direction, by the use of forced air which “blows out” the diameter of the bubble, and in a lengthwise direction of the bubble, by the action of a winding element which pulls the bubble through the machinery. External air can also be introduced around the bubble circumference to cool the melt as it exits the die. Film width can be varied by introducing more or less internal air into the bubble thus increasing or decreasing the bubble size. Film thickness can be controlled by increasing or decreasing the speed of the draw roll or nip roll to control the draw-down rate. The bubble can be collapsed after passing through the draw or nip rolls. The cooled film can then be processed further by cutting or sealing to produce a variety of consumer products.

For a cast film process, components of the multilayer film can be extruded onto a turning roll, where the multilayer film is quenched on one side by the roll. The speed of the roller may be used to control the draw ratio and the final film thickness. The multilayer film can then be sent to a second roller for cooling on the other side.

The core layer can be from 70 wt % to 90 wt % of the multilayer film based on a total weight of the multilayer film. All individual values and subranges from 70 wt % to 90 wt % are included. For example, the core layer can be from a lower limit of 70, 71, 72, 73, 74, or 75 wt % to an upper limit of 90, 89, 88, 87, 86, or 85 wt % based on a total weight of the multilayer film.

The core layer may have a thickness of from 15 microns (μm) to 60 μm. All individual values and subranges from 15 to 60 μm are included. For example, the core layer can be from a lower limit of 15, 17.5, 20, 22.5, or 25 μm to an upper limit of 60, 57.5, 52.5, or 50 μm.

Each outer layer can respectively be from 5 wt % to 15 wt % of the multilayer film based on a total weight of the multilayer film. All individual values and subranges from 5 wt % to 15 wt % are included. For example, an outer layer can be from a lower limit of 5, 5.5, 6, 6.5, 7, or 7.5 wt % to an upper limit of 15, 14.5, 14, 13.5, 13, or 12.5 wt % based on the total weight of the multilayer film.

Each outer layer can have a thickness of from 1 μm to 10 μm. All individual values and subranges from 1 μm to 10 μm are included. For example, an outer layer can have a thickness of from a lower limit of 1, 1.5, 1.75, 2, or 2.5 μm to an upper limit of 10, 9.5, 9, 8.5, or 8 μm.

The multilayer film can have a thickness from 17 μm to 80 μm. All individual values and subranges from 17 μm to 80 μm are included. For example, the multilayer film can have a thickness of from a lower limit of 17, 20.5, 24, 26.5, or 30 μm to an upper limit of 80, 76.5, 73, 69.5, or 66 μm.

In various embodiments described herein, the multilayer film is a laminate having less than 1 wt % of anti-block or slip additives. For example, the multilayer film may have from 0 wt % to 1 wt %, from 0 wt % to 0.75 wt %, from 0 wt % to 0.5 wt %, from 0 wt % to 0.25 wt %, or be free of anti-block or slip additives.

As mentioned, the multilayer films described herein may advantageously have improved blocking, as compared to other films, despite the limited or lack of anti-block or slip additives. Additionally, the multilayer films may advantageously have comparable or even improved elasticity, as compared to other films. In some particular embodiments, the multilayer film may have an unwinding force of less than 1 N/50 mm after 12 weeks at a length ranging from 10 m to 50 m.

### Articles

In various embodiments, the multilayer films disclosed herein can be used to form articles such as disposable personal care articles. Such articles can be formed from any of the multilayer films described herein. Examples of disposable personal care articles that can be formed from multilayer films of various embodiments can include diapers, training pants, adult incontinence products, and feminine hygiene products. Such personal care articles can be formed using techniques known to those of skill in the art based on the teachings herein and based on the particular use for the article.

### Testing Methods

The test methods include the following:

### Melt Index (I₂)

Melt index (I₂) was measured in accordance with ASTM D-1238 at 190° C. at 2.16 kg. The values are reported in g/10 min, which corresponds to grams eluted per 10 minutes.

### Melt Flow Rate (MFR)

MFR was measured in accordance with ASTM D-1238 at 230° C. at 2.16 kg. The values are reported in g/10 min, which corresponds to grams eluted per 10 minutes.

### Density

Samples for density measurement were prepared according to ASTM D4703 and reported in grams/cubic centimeter (g/cc or g/cm³). Measurements were made within one hour of sample pressing using ASTM D792, Method B.

### Melting Point

Differential Scanning Calorimetry (DSC) is used to measure the melting and crystallization behavior of a polymer over a wide range of temperatures. For example, the TA Instruments Q1000 DSC, equipped with an RCS (refrigerated cooling system) and an autosampler is used to perform this analysis. The instrument is first calibrated using the software calibration wizard. A baseline is obtained by heating a cell from −80° C. to 280° C. without any sample in an aluminum DSC pan. Sapphire standards are then used as instructed by the calibration wizard. Next, 1 to 2 milligrams (mg) of a fresh indium sample are analyzed by heating the standards sample to 180° C., cooling to 120° C. at a cooling rate of 10° C./minute, and then keeping the standards sample isothermally at 120° C. for 1 minute. The standards sample is then heated from 120° C. to 180° C. at a heating rate of 10° C./minute. Then, it is determined that indium standards sample has heat of fusion (H_{f})=28.71±0.50 Joules per gram (J/g) and onset of melting=156.6° C.±0.5° C. Test samples are then analyzed on the DSC instrument.

During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tₘ), peak crystallization temperature (T_{c}), onset crystallization temperature (Tc onset), heat of fusion (H_{f}) (in Joules per gram), and the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (H_{f}) and the peak melting temperature are reported from the second heat curve. Peak crystallization temperature and onset crystallization temperature are determined from the cooling curve.

### Elastic Performance

Elastic properties of film samples were evaluated by performing a 2 cycle hysteresis test according to ASTM D5459. In particular, 25 mm wide specimens were stretched to 100% elongation with a speed of 250 mm/min and immediately retracted back to 0% elongation with the same speed. After 60 s, the second cycle was performed. The grip distance was set to 50 mm. Permanent set values were reported. Lower values for permanent set are indicative of improved elastic performance.

### Roll Blocking

Roll blocking was evaluated by unwinding a 50 m roll on a Dr. Collin Cast Rewinder with a load cell capacity of 25 kg and measuring the force. The roll was unwound at a speed of 10 m/min and the film had a width of 180 mm. The force per 50 mm length was reported in N/50 mm after 10, 20 30, 40, and 50 m of unwound film sample. The blocking behavior was evaluated at 1 and 12 weeks after extrusion.

### EXAMPLES

The following examples illustrate features of the present disclosure but are not intended to limit the scope of the disclosure.

In the Examples, the following materials were used:

Granic 421 is calcium carbonate masterbatch (73% CaCO₃ in LLDPE), commercially available from Granic Group (Tarragona, Spain);

POLYBATCH™ FSU-105-E is a slip and antiblock masterbatch including 5% erucamide as a slip agent and 10% silica as an antiblock agent, commercially available from Schulmann;

STYRON A-TECH™ 1200 is a high-impact polystyrene containing approximately 8 wt % polybutadiene rubber, having a density of 1.05 g/cc (measured in accordance with ISO 1388), and having a mass melt flow of 5 g/10 min (measured at 200° C. and 5 kg in accordance with ISO 1133), commercially available from TRINSEO;

INFUSE™ 9107 is an ethylene-alpha olefin block copolymer having an I₂ of 1 g/10 min and a density of 0.866 g/cc, commercially available from The Dow Chemical Company, Midland, Mich.;

VERSIFY™ 3300 is a propylene-based plastomer (propylene block copolymer) having an MFR of 8 g/10 min and a density of 0.868 g/cc, commercially available from The Dow Chemical Company, Midland, Mich.;

ELVALOY™ AC 2615 is an ethylene acrylate copolymer including 9 wt % methyl acrylate as a comonomer, having an I₂ of 6.0 g/10 min and a density of 0.930 g/cc, commercially available from The Dow Chemical Company, Midland, Mich.;

ELVALOY™ AC 1609 is an ethylene acrylate copolymer including 15 wt % ethyl acrylate as a comonomer, having an I₂ of 6.0 g/10 min and a density of 0.930 g/cc, commercially available from The Dow Chemical Company, Midland, Mich.; and

NUCREL™ 3990 is an ethylene acid copolymer including 9 wt % acrylic acid and having an I₂ of 10.0 g/10 min, commercially available from The Dow Chemical Company, Midland, Mich.

The following multilayer films of Table 1 had an ABC 3 layer structure coextrusion. The coextrusion was performed on a Collin coextrusion Cast Film Line equipped with 25 mm extruders under the following conditions: layer ratio (A/B/C): 10/80/10; throughput: 10 kg/hour; take of speed: 12 m/min; die gap: 0.8 mm

TABLE 1
Film Samples 1-2 and Comparative Film Samples C1-C3

| Sample | | | | Thickness |
|---|---|---|---|---|
| # | Layer A | Layer B | Layer C | (μm) |
| C1 | 75% INFUSE ™ 9107 | 98% INFUSE ™ 9107 | 75% INFUSE ™ 9107 | 50 |
| | 22% Granic 421 | 2% POLYBATCH ™ | 22% Granic 421 | |
| | 3% POLYBATCH ™ | FSU-105-E | 3% POLYBATCH ™ | |
| | FSU-105-E | | FSU-105-E | |
| C2 | 70% VERSIFY ™ | 100% INFUSE ™ | 70% VERSIFY ™ | 50 |
| | 3300 | 9107 | 3300 | |
| | 30% STYRON A- | | 30% STYRON A- | |
| | TECH ™ 1200 | | TECH ™ 1200 | |
| C3 | 100% ELVALOY ™ | 100% INFUSE ™ | 100% ELVALOY ™ | 50 |
| | AC 2615 | 9107 | AC 2615 | |
| 1 | 100% ELVALOY ™ | 100% INFUSE ™ | 100% ELVALOY ™ | 50 |
| | AC 1609 | 9107 | AC 1609 | |
| 2 | 100% NUCREL ™ | 100% INFUSE ™ | 100% NUCREL ™ | 50 |
| | 3990 | 9107 | 3990 | |

The blocking was measured at 1 week and 12 weeks after extrusion for lengths of 10 m, 20 m, 30 m, 40 m, and 50 m for Comparative Samples 1-3 and Samples 1-2, and the results are reported in Table 2 as N/50 mm.

TABLE 2
Summary of Blocking Results

| | C1 | | C2 | | C3 | | 1 | | 2 | |
|---|---|---|---|---|---|---|---|---|---|---|
| | 1 | 12 | 1 | 12 | 1 | 12 | 1 | 12 | 1 | 12 |
| | week | weeks | week | weeks | week | weeks | week | weeks | week | weeks |
| 10 m | 3 | 2.9 | 0.9 | 0.9 | 4.2 | 6.4 | 1 | 1.3 | 0.5 | 0.5 |
| 20 m | 5.3 | 9.0 | 1.1 | 1.2 | 4.7 | 7.3 | 1 | 1.4 | 0.4 | 0.6 |
| 30 m | 7.5 | break | 1.5 | 1.4 | 5.4 | 7.8 | 1.1 | 1.5 | 0.4 | 0.6 |
| 40 m | 10.0 | n/a | 2.0 | 1.7 | 6.2 | 8.2 | 1.1 | 1.6 | 0.4 | 0.6 |
| 50 m | 11.8 | n/a | 1.8 | 2.1 | 6.3 | 8.4 | 1.2 | 1.7 | 0.5 | 0.6 |

As can be seen in Table 2, the films formed from Samples 1 and 2 exhibit improved aging as compared to the film formed from Comparative Sample 1. Without being bound by theory, it is believed that the antiblock additives (CaCO₃ and silica) in Comparative Sample 1 migrate away from the surface over time, leading to reduced blocking over time. It is believed that Comparative Sample 3 demonstrated inferior blocking performance, because it includes ELVALOY™ AC 2615, which includes 15 wt % ethyl acrylate. This amount of acrylate comonomer made the film too tacky, thereby negatively impacting the blocking performance.

Elastic performance was measured for Comparative Samples 1-3 and Samples 1 and 2. The results are reported in Table 3 as force (N) at permanent set for cross-direction (CD) and machine-direction (MD).

TABLE 3
Elastic Performance Testing Results

| Sample # | CD | MD |
|---|---|---|
| C1 | 7.5 | 6 |
| C2 | 8.5 | 14 |
| C3 | 6.0 | 7.0 |
| 1 | 7.0 | 6.0 |
| 2 | 6.3 | 6.6 |

As shown in Table 3, each of Samples 1 and 2 had an elasticity comparable to that of Comparative Sample 1 and Comparative Sample 3, although they also exhibited improved blocking over time as compared to these samples. Samples 1 and 2 further demonstrated improved elastic performance over Comparative Example 2, which included polystyrene and polypropylene to keep blocking under control.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multilayer elastic film comprising a core layer, a first outer layer and a second outer layer, wherein:
the core layer comprises at least 75 wt % of an ethylene/alpha-olefin block copolymer having a density of 0.850 g/cc to 0.890 g/cc and a melt index (I₂) of from 0.5 g/10 min to 5.0 g/10 min, and
the first outer layer and the second outer layer each comprise at least 75 wt % of an ethylene-based copolymer, wherein the ethylene-based copolymer is selected from the group consisting of:
(I) greater than 50 wt % of ethylene, from 5 to 16 wt % of an α,β-ethylenically unsaturated C₃-C₈ carboxylic acid, and optionally, from 0.5 to 10 wt % of an alkyl acrylate;
(II) from 86 to 95 wt % of ethylene, and from 5 to 14 wt % of an alkyl acrylate; and
(III) combinations thereof.

2. The multilayer elastic film of claim 1, wherein the ethylene/alpha-olefin block copolymer has a melt temperature of from 115° C. to 125° C.

3. The multilayer elastic film of claim 1, wherein the ethylene/alpha-olefin block copolymer has a molecular weight distribution (MWD=M_{w}/Mₙ) of from 2 to 3.

4. The multilayer elastic film of claim 1, wherein the I₂ of the ethylene/alpha-olefin block copolymer is from 0.5 to 2.0 g/10 min.

5. The multilayer elastic film of claim 1, wherein the core layer comprises 75 to 100 wt % of the ethylene/alpha-olefin block copolymer.

6. A multilayer elastic film comprising a core layer, a first outer layer and a second outer layer, wherein:
the core layer comprises at least 75 wt % of a propylene-based plastomer having a density of 0.860 g/cc to 0.900 g/cc and a melt flow rate (MFR) of from 0.5 g/10 min to 5.0 g/10 min, and
the first outer layer and the second outer layer each comprise at least 75 wt % of an ethylene-based copolymer, wherein the ethylene-based copolymer is selected from the group consisting of:
(I) greater than 50 wt % of ethylene, from 5 to 16 wt % of an α,β-ethylenically unsaturated C₃-C₈ carboxylic acid, and optionally, from 0.5 to 10 wt % of an alkyl acrylate;
(II) from 86 to 95 wt % of ethylene, and from 5 to 14 wt % of an alkyl acrylate; and
(III) combinations thereof.

7. The multilayer elastic film of claim 1, wherein the first outer layer and the second outer layer each comprise at least 75 wt % of the ethylene-based copolymer.

8. The multilayer elastic film of claim 1, wherein the first outer layer and the second outer layer each comprise from 75 to 100 wt % of the ethylene-based copolymer.

9. The multilayer elastic film of claim 1, wherein the ethylene-based copolymer of the first outer layer, the second outer layer, or both has a melt index (I₂) of from 4.0 g/10 min to 20.0 g/10 min.

10. The multilayer elastic film of claim 1, wherein the ethylene-based copolymer of the first outer layer, the second outer layer, or both has greater than 80 wt % of ethylene and from 7 to 11 wt % of an α,β-ethylenically unsaturated C₃-C₈ carboxylic acid.

11. The multilayer elastic film of claim 1, wherein the ethylene-based copolymer of the first outer layer, the second outer layer, or both has from 88 to 94 wt % of ethylene, and from 6 to 12 wt % of an alkyl acrylate.

12. The multilayer elastic film of claim 1, wherein the ethylene-based copolymer of the first outer layer, the second outer layer, or both has a density of from 0.920 g/cc to 0.950 g/cc.

13. The multilayer elastic film of claim 1, wherein the multilayer elastic film includes less than 1 wt % of antiblock or slip additives.

14. The multilayer elastic film of claim 1, wherein the multilayer elastic film is a blown film or a cast film.

15. The multilayer elastic film of claim 1, wherein the multilayer elastic film is a cast film, the cast film having an unwinding force of less than 1 N/50 mm after 12 weeks at a length ranging from 10 m to 50 m.

16. The multilayer elastic film of claim 6, wherein the first outer layer and the second outer layer each comprise at least 75 wt % of the ethylene-based copolymer.

17. The multilayer elastic film of claim 6, wherein the ethylene-based copolymer of the first outer layer, the second outer layer, or both has a melt index (I₂) of from 4.0 g/10 min to 20.0 g/10 min.

18. The multilayer elastic film of claim 6, wherein the ethylene-based copolymer of the first outer layer, the second outer layer, or both has greater than 80 wt % of ethylene and from 7 to 11 wt % of an α,β-ethylenically unsaturated C₃-C₈ carboxylic acid.

19. The multilayer elastic film of claim 6, wherein the ethylene-based copolymer of the first outer layer, the second outer layer, or both has from 88 to 94 wt % of ethylene, and from 6 to 12 wt % of an alkyl acrylate.

20. The multilayer elastic film of claim 6, wherein the ethylene-based copolymer of the first outer layer, the second outer layer, or both has a density of from 0.920 g/cc to 0.950 g/cc
